(19) United States
(12) Patent Application Publication
(10) Pub. No.: US 2003/0004263 A1
(43) Pub. Date: Jan. 2, 2003

(54) Reactive hot melt adhesive

(76) Inventors: Robert C. Schmidt JR., Great Meadows, NJ (US); Michael T. Gefri, Blairstown, NJ (US)

Correspondence Address: Cynthia L. Foulke, National Starch & Chemical Company, Box 6500, Bridgewater, NJ, 08807-0500, US

(21) Appl. No.: 09/882,241

(22) Filed: Jun. 15, 2001

(51) Int. Cl. C08K 3/00

(52) U.S. Cl. 524/589

(57) ABSTRACT

A reactive hot melt adhesive that may be used to reduce or eliminate bondline failure in article of manufacture that contain residual stress prior to cure of the adhesive.

### FIELD OF THE INVENTION

The invention relates to hot melt adhesives, in particular reactive hot melt adhesives having improved green strength.

### BACKGROUND OF THE INVENTION

Hot melt adhesives are solid at room temperature but, upon application of heat, melt to a liquid or fluid state in which form they are applied to a substrate. On cooling, the adhesive regains its solid form. The hard phase(s) formed upon cooling the adhesive imparts all of the cohesion (strength, toughness, creep and heat resistance) to the final adhesive. Curable hot melt adhesives, which are also applied in molten form, cool to solidify and subsequently cure by a chemical crosslinking reaction. An advantage of hot melt curable adhesives over traditional liquid curing adhesives is (1) their ability to provide “green strength” upon cooling prior to cure and (2) provide adhesives of very low crosslinking density and thus high levels of flexibility and toughness.

The majority of reactive hot melts are moisture-curing urethane adhesives. These adhesives consist primarily of isocyanate terminated polyurethane prepolymers that react with surface or ambient moisture in order to chain-extend, forming a new polyurethane polymer. Polyurethane prepolymers are conventionally obtained by reacting diols with diisocyanates. Pure diols are favored for use, instead of polyols with higher functionality, to avoid excessive branching that can lead to poor pot stability. Methylene bisphenyl diisocyanate (MDI) is favored over lower molecular weight isocyanates to minimize volatility. Cure is obtained through the diffusion of moisture from the atmosphere or the substrates into the adhesive, and subsequent reaction. The reaction of moisture with residual isocyanate forms carbamic acid. This acid is unstable, decomposing into an amine and carbon dioxide. The amine reacts rapidly with isocyanate to form a urea. The final adhesive product is a lightly crosslinked material held together primarily through hydrogen bonding, urea groups and urethane groups.

The prior art discloses that that the performance of reactive hot melt adhesives for most applications may be substantially improved by the incorporation of acrylic polymers into conventional polyurethane adhesives, in particular reactive hydroxy-containing and non-reactive acrylic copolymers. Improvement in green strength may be obtained by adding higher molecular weight polymers (reactive or not) and/or incorporating crystalline diols, most commonly polyester diols.

These prior art adhesives are extremely tough, with outstanding low temperature flexibility, heat and chemical resistance, and specific adhesion to polar substrates. Adhesion to a wide range of other substrates may be obtained through the addition of adhesion promoters such as silane coupling agents. Despite these advances in the art, there remains a need for improvements in reactive hot melt technology to expand the application of such adhesives and their effectiveness in such applications. The present invention addresses this need.

### SUMMARY OF THE INVENTION

The invention provides a moisture curable reactive hot melt adhesive having improved green strength.

One aspect of the invention is directed to the use of a polyurethane reactive hot melt composition comprising an isocyanate terminated prepolymer derived from the condensation reaction of a blend of ester ethers and functional acrylic polyols to reduce or eliminate bondline failures in articles of manufacture that contain residual stress prior to cure of the adhesive. The method of the invention comprises using as the adhesive a reactive hot melt comprising from about 0 to about 60 parts of a polyether polyol, from about 0 to about 40 parts of a polyester polyol, from about 1 to about 75 parts of a functional acrylic, from about 0 to about 30 parts of a non-reactive acrylic, from about 2 to about 25 parts of an isocyanate and, if desired, a catalyst. A preferred isocyanate is methylenebisphenyldiisocyanate (MD I). A preferred catalyst is 2,2′ dimorpholinodiethyl ether (DMDEE).

Another aspect of the invention is directed to a method for bonding materials together which materials are subject to stress prior to adhesive cure. The method comprises applying the reactive hot melt adhesive composition of the invention in a liquid form to a first substrate, bringing a second substrate in contact with the composition applied to the first article, and subjecting the applied composition to conditions which will allow the composition to cool and cure to an irreversible solid form, said conditions comprising moisture.

Still another aspect of the invention is directed to an article of manufacture comprising the adhesive of the invention.

### DETAILED DESCRIPTION OF THE INVENTION

The disclosures of all documents cited herein are incorporated in their entireties by reference.

The term “parts” or “parts by weight,” as used herein refers to parts by weight of the adhesive composition.

It has now been discovered that the addition of low molecular weight acrylic polymers to hot melt polyurethane adhesives in amounts not heretofore taught in the art improves green strength and can advantageously be used in assemblies that contain residual stress prior to adhesive cure.

The moisture curable, hot melt polyurethane adhesives of the invention may be prepared through the reaction of a mixture of ester ethers and functional acrylic polymers with an isocyanate-containing compound at a temperature of from about 250° F. to about 275° F.

Adhesives for use in the practice of the invention adhesive comprise from about 0 to about 60 parts of a polyether polyol, from about 0 to about 40 parts of a polyester polyol, from about 1 to about 75 parts of a functional acrylic, from about 0 to about 30 parts of a non-reactive acrylic, from about 2 to about 25 parts of an isocyanate and, if desired, a catalyst. More preferred for use are adhesives comprising from about 15 to about 25 parts of a polyester polyol, from about 15 to about 50 parts of a functional acrylic, and from about 2 to about 25 parts of an isocyanate, MDI being preferred. The polyether polyol component is preferably use in amounts of from about 20 to about 40 parts. A preferred curing catalyst is DMDEE, and is used in amounts effective to cure of the adhesive. Generally up to about 0.2 parts of DMDEE is generally sufficient for this purpose.

It has been unexpectedly discovered that when using an adhesive of the type described herein, the amount of energy necessary to cause glue line failure compared to previous adhesives is increased. This is achieved with equal or higher adhesive stress levels, and elongation values than currently used adhesives. The result is at least a five-fold increase in the energy required to rupture the bondline. In addition, use of the adhesive in accordance with the invention does not sacrifice open time compared to currently used products. A typical minimum for this property is 3 minutes. Use of the invention eliminates bondline failures in assemblies that contain residual stress. Such stress causes auto debonding with time when the uncured adhesive cannot support said residual stress, or debonding that occurs before the adhesive cures as a result of stress imparted by outside influence such as handling or assembly with other parts.

The urethane prepolymers that can be used to prepare the adhesives of the invention are those conventionally used in the production of polyurethane hot melt adhesive compositions. Any suitable compound, which contains two or more isocyanate groups, may be used for preparing the urethane prepolymers. Typically from about 2 to about 25 parts by weight of an isocyanate is used.

Organic polyisocyanates, which may be used to practice the invention, include alkylene diisocyanates, cycloalkylene diisocyanates, aromatic diisocyanates and aliphatic-aromatic diisocyanates. Specific examples of suitable isocyanate-containing compounds include, but are not limited to, ethylene diisocyanate, ethylidene diisocyanate, propylene diisocyanate, butylene diisocyanate, trimethylene diisocyanate, hexamethylene diisocyanate, toluene diisocyanate, cyclopentylene-1,3-diisocyanate, cyclo-hexylene-1,4-diisocyanate, cyclohexylene-1,2-diisocyanate, 4,4′-diphenylmethane diisocyanate, 2,2-diphenylpropane-4,4′-diisocyanate, xylylene diisocyanate, 1,4-naphthylene diisocyanate, 1,5-naphthylene diisocyanate, m-phenylene diisocyanate, p-phenylene diisocyanate, diphenyl-4,4′-diisocyanate, azobenzene-4,4′-diisocyanate, diphenylsulphone-4,4′-diisocyanate, 2,4-tolylene diisocyanate, dichlorohexa-methylene diisocyanate, furfurylidene diisocyanate, 1-chlorobenzene-2,4-diisocyanate, 4,4′,4″-triisocyanatotriphenylmethane, 1,3,5-triisocyanato-benzene, 2,4,6-triisocyanato-toluene, 4,4′-dimethyldiphenyl-methane-2,2′,5,5-tetratetraisocyanate, and the like. While such compounds are commercially available, methods for synthesizing such compounds are well known in the art. Preferred isocyanate-containing compounds are methylenebisphenyldiisocyanate (MDI), isophoronediisocyanate (IPDI) and toluene diisocyanate (TDI).

Most commonly, the prepolymer is prepared by the condensation polymerization of a polyisocyanate with a polyol, most preferably the polymerization of a diisocyanate with a diol. The polyols used include polyhydroxy ethers (substituted or unsubstituted polyalkylene ether glycols or polyhydroxy polyalkylene ethers), polyhydroxy polyesters, the ethylene or propylene oxide adducts of polyols and the monosubstituted esters of glycerol, as well as mixtures thereof. The polyol is typically used in an amount of between about 1 to about 70 parts by weight.

Examples of polyether polyols include a linear and/or branched polyether having plural numbers of ether bondings and at least two hydroxyl groups, and contain substantially no functional group other than the hydroxyl groups. Examples of the polyether polyol may include polyoxyalkylene polyol such as polyethylene glycol, polypropylene glycol, polybutylene glycol and the like. Further, a homopolymer and a copolymer of the polyoxyalkylene polyols may also be employed. Particularly preferable copolymers of the polyoxyalkylene polyols may include an adduct at least one compound selected from the group consisting of ethylene glycol, propylene glycol, diethylene glycol, dipropylene glycol, triethylene glycol, 2-ethylhexanediol-1,3, glycerin, 1,2,6-hexane triol, trimethylol propane, trimethylol ethane, tris(hydroxyphenyl)propane, triethanolamine, triisopropanolamine, ethylenediamine and ethanolamine; with at least one compound selected from the group consisting of ethylene oxide, propylene oxide and butylene oxide.

A number of suitable polyols are available commercially. Non-limiting examples include CP4701 (Dow Chemicals), Niax 11-34 (Union Carbide Corp), Desmophen 3900 (Bayer), Propylan M12 (Lankro Chemicals), Highflex 303 (Daiichi Kogyo Seiyaku K.K.) and Daltocel T 32-75 (ICI). “Polymer polyols” are also suitable, i.e. graft polyols containing a proportion of a vinyl monomer, polymerised in situ, e.g., Niax 34-28.

Polyester polyols are formed from the condensation of one or more polyhydric alcohols having from 2 to 15 carbon atoms with one or more polycarboxylic acids having from 2 to 14 carbon atoms. Examples of suitable polyhydric alcohols include ethylene glycol, propylene glycol such as 1,2-propylene glycol and 1,3-propylene glycol, glycerol, pentaerythritol, trimethylolpropane, 1,4,6-octanetriol, butanediol, pentanediol, hexanediol, dodecanediol, octanediol, chloropentanediol, glycerol monallyl ether, glycerol monoethyl ether, diethylene glycol, 2-ethylhexanediol-1,4, cyclohexanediol-1,4,1,2,6-hexanetriol, 1,3,5-hexanetriol, 1,3-bis-(2-hydroxyethoxy)propane and the like. Examples of polycarboxylic acids include phthalic acid, isophthalic acid, terephthalic acid, tetrachlorophthalic acid, maleic acid, dodecylmaleic acid, octadecenylmaleic acid, fumaric acid, aconitic acid, trimellitic acid, tricarballylic acid, 3,3′-thiodipropionic acid, succinic acid, adipic acid, malonic acid, glutaric acid, pimelic acid, sebacic acid, cyclohexane-1,2-dicarboxylic acid, 1,4-cyclohexadiene-1,2-dicarboxylic acid, 3-methyl-3,5-cyclohexadiene-1,2-dicarboxylic acid and the corresponding acid anhydrides, acid chlorides and acid esters such as phthalic anhydride, phthaloyl chloride and the dimethyl ester of phthalic acid. Preferred polycarboxylic acids are the aliphatic and cycloaliphatic dicarboxylic acids containing no more than 14 carbon atoms and the aromatic dicarboxylic acids containing no more than 14 atoms.

In addition, the urethane prepolymers may be prepared by the reaction of a polyisocyanate with a polyamino or a polymercapto-containing compound such as diamino polypropylene glycol or diamino polyethylene glycol or polythioethers such as the condensation products of thiodiglycol either alone or in combination with other glycols such as ethylene glycol, 1,2-propylene glycol or with other polyhydroxy compounds disclosed above. In accordance with one embodiment of the invention, the hydroxyl containing acrylic polymer may function as the polyol component, in which case, no additional polyol need be added to the reaction.

Further, small amounts of low molecular weight dihydroxy, diamino, or amino hydroxy compounds may be used such as saturated and unsaturated glycols, e.g., ethylene glycol or condensates thereof such as diethylene glycol, triethylene glycol, and the like; ethylene diamine, hexamethylene diamine and the like; ethanolamine, propanolamine, N-methyidiethanolamine and the like.

Virtually any ethylenically unsaturated monomer containing a functionality greater than one may be utilized in the compositions of the present invention. Functional monomers include, without limitation acid, hydroxy, amine, isocyanate, and thio functional monomers. Hydroxyl functionality is preferred and is described in detail herein.

Most commonly employed are hydroxyl substituted C₁ to C₁₂ esters of acrylic and methacrylic acids including, but not limited to hydroxyl substituted methyl acrylate, ethyl acrylate, n-butyl acrylate, 2-ethylhexyl acrylate, isobutyl acrylate, n-propyl or iso-propyl acrylate or the corresponding methacrylates. Mixtures of compatible (meth)acrylate monomers may also be used. Additional monomers that may be used include the hydroxyl substituted vinyl esters (vinyl acetate and vinyl propionate), vinyl ethers, fumarates, maleates, styrene, acrylonitrile, etc. as well as comonomers thereof.

These monomers may blended with other copolymerizable comonomers as formulated so as to have a wide range of Tg values, as between about −48° C. and 105° C., preferably 15° C. to 85° C. Suitable comonomers include the C₁ to C₁₂ esters of acrylic and methacrylic acids including, but not limited to methyl acrylate, ethyl acrylate, n-butyl acrylate, isobutyl acrylate, 2-ethylhexyl acrylate, n-propyl or iso-propyl acrylate or the corresponding methacrylates. Mixtures of compatible (meth)acrylate monomers may also be used. Additional monomers that may be used include the vinyl esters (vinyl acetate and vinyl propionate), vinyl ethers, fumarates, maleates, styrene, acrylonitrile, ethylene, etc. as well as comonomers thereof. The hydroxyl containing monomers may be the same or different from the monomers used in the remainder of the acrylic polymerization. The particular monomers selected will depend, in large part, upon the end use for which the adhesives are intended. Thus, adhesives to be used in pressure sensitive applications or in applications wherein adhesion to metal is required will be selected to obtain a lower Tg polymer than may be desired in non-pressure sensitive applications or those involving more easily bonded substrates.

When the adhesive is to be prepared utilizing monomeric materials, the respective monomers may be added to the polyols and polymerized therein prior to formation of the prepolymer or may be added to the already formed prepolymer and the acrylic polymerization subsequently performed. In the case of polyamino or polymercapto containing prepolymers, in-situ vinylic polymerization must be performed only in the pre-formed prepolymer.

The hydroxyl containing ethylenically unsaturated monomer is polymerized using conventional free radical polymerization procedures to a relatively low molecular weight. For purposes of clarification, use of the term “low molecular weight” means number average molecular weights in the range of approximately 2,000 to 50,000, preferred for use are monomers having an average molecular weight in the rage of from about 5,000 to about 30,000. Molecular weight distribution is characterized by Gel Permeation Chromatography using a PL Gel, Mixed 10 micron column, a Shimadzu Model RID 6A Detector with a tetrahydrofuran carrier solvent at a flow rate of 1 milliliter per minute. The low molecular weight is obtained by careful monitoring and controlling the reaction conditions and, generally, by carrying out the reaction in the presence of a chain transfer agent such as dodecyl mercaptan. Subsequent to the polymerization of the ethylenically unsaturated monomer(s), the polyisocyanate and any additional ingredients required for the urethane prepolymer forming reaction are added and that reaction is carried out using conventional condensation polymerization procedures. In this manner, the resultant isocyanate terminated urethane prepolymer forms the reactive curing hot melt adhesive described above which contains about 10 to 70% of the urethane prepolymer and 30 to 90% of the low molecular weight hydroxyl containing polymer.

It is also possible to polymerize the low molecular weight polymer in the presence of the already formed isocyanate terminated urethane prepolymer. This method has the drawback of subjecting the prepolymer to unnecessary heating during the acrylic polymerization, heating that might result in branching, viscosity increase, depletion of needed isocyanate groups and possible gellation. Although these disadvantages are subject to control, more stringent control of conditions are required as compared to polymerization in the non-isocyanate functional urethane components. When the reaction is run in the polyol or other non-isocyanate containing component, there is also the advantage of lower reaction viscosities and reduced exposure to isocyanate vapors because of the lesser amount of heating required.

Optionally, the hydroxyl containing functionality may be introduced into the adhesive in the form of pre-polymerized low molecular weight hydroxyl containing polymers. In the latter case, typical polymers include hydroxyl substituted butyl acrylate, hydroxylated butyl acrylate/methyl methacrylate copolymers, hydroxylated ethyl acrylate/methyl methacrylate copolymers, and the like. Preferred polymers have a number average molecular weight of 5,000 to 30,000 and a hydroxyl number of 4 to 30. If used in the form of low molecular weight polymers, the polymers may be blended with the polyol prior to reaction thereof with the isocyanate or they may be added directly to the isocyanate terminated prepolymer.

While the adhesives may be used directly as described above, if desired the adhesives of the present invention may also be formulated with conventional additives which are compatible with the composition. Such additives include plasticizers, compatible tackifiers, curing catalysts, dissociation catalysts, fillers, anti-oxidants, pigments, adhesion promoters, stabilizers and the like. Conventional additives which are compatible with a composition according to this invention may simply be determined by combining a potential additive with the composition and determining if they are compatible. An additive is compatible if it is homogenous within the product. Non-limited examples of suitable additives include, without limitation, rosin, rosin derivatives, rosin ester, aliphatic hydrocarbons, aromatic hydrocarbons aromatically modified aliphatic hydrocarbons, terpenes, terpene phenol, modified terpene, high molecular weight hindered phenols and multifunctional phenols such as sulfur and phosphorous-containing phenol, terpene oligomers, DMDEE, paraffin waxes, microcrystalline waxes and hydrogenated castor oil.

The reactive hot melt adhesives of the invention may also contain flame retardant components. Fire retardant additives known in the art for imparting flame resistance to polyurethane compositions may be added. Such compounds include inorganic compounds such as a boron compound, aluminum hydroxide, antimony trioxide and the like, and other halogen compounds including halogen-containing phosphate compounds such as tris(chloroethyl)phosphate, tris(2,3-dichloropropyl)-phosphate, and the like. These and other flame retarding compositions are described in U.S. Pat. Nos. 3,773,695 4,266,042, 4,585,806, 4,587,273 and 4,849,467, and European Patent No. 0 587 942. In a preferred embodiment, ethylenebistetrabromophthalimide and/or tris(2,3-dibromopropyl)-isocyanurate is added as a prime flame retardant component. The ethylenebistetrabromophthalimide and/or tris(2,3-dibromopropyl)isocyanurate may be used with or without other flame retardants. The composition may further comprise a chlorinated paraffin and/or an aryl phosphate ester as a further flame retardant component. The optional chlorinated paraffin imparts flame retardancy as well as performing as a viscosity modifier. The aryl phosphate ester further imparts improved adhesion to the substrates. The flame retardant polyurethane-based reactive hot melt adhesives when used in the practice of the invention gives excellent flame retardancy while maintaining the targeted properties of the base polymer, such as good green strength, controlled setting speed and good thermal stability at elevated temperatures.

This invention also provides a method for bonding articles together which comprises applying the reactive hot melt adhesive composition of the invention in a liquid melt form to a first article, bringing a second article in contact with the composition applied to the first article, and subjecting the applied composition to conditions which will allow the composition to cool and cure to a composition having an irreversible solid form, said conditions comprising moisture. The composition is typically distributed and stored in its solid form, and is stored in the absence of moisture. When the composition is ready for use, the solid is heated and melted prior to application. Thus, this invention includes reactive polyurethane hot melt adhesive compositions in both its solid form, as it is typically to be stored and distributed, and its liquid form, after it has been melted, just prior to its application.

After application, to adhere articles together, the reactive hot melt adhesive composition is subjected to conditions that will allow it to solidify and cure to a composition that has an irreversible solid form. Solidification (setting) occurs when the liquid melt is subjected to room temperature. Curing, i.e. chain extending, to a composition that has an irreversible solid form, takes place in the presence of ambient moisture.

As used herein, “irreversible solid form” means a solid form comprising polyurethane polymers extended from the aforementioned polyurethane prepolymers. The composition having the irreversible solid form typically can withstand temperatures of up to 150° C. Using ethylenebistetrabromophthalimide as a flame retardant, the thermal stability of the irreversible solid can be improved.

The reactive hot melt composition of the invention is useful for bonding articles composed of a wide variety of substrates (materials), including but not limited to wood, metal glass and textiles. Non-limiting examples include use in laminating such as recreational vehicle (RV) panels including sidewall panels and roofs, office partitions, white boards and structural insulated panels, for use in veneering such as in floors and furniture, millwork, speaker assembly, shoes, as a glazing/backbedding compound, in appliance assembly, in furniture assemble and in the manufacture of doors, including entry doors, garage doors, and the like. RVs, as referred to herein, is used broadly and includes vehicles whether motorized or not, e.g., mobile home, trailers, boats and the like. It will be appreciated that the adhesive of the invention finds particular usefulness when used in assemblies that contain residual stress that cause auto debonding with time when the uncured adhesive cannot support said residual stress, or debonding that occurs before the adhesive cures as a result of stress imparted by outside influence such as handling or assembly with other parts.

The invention is further illustrated by the following non-limiting examples.

### EXAMPLES

In the Examples that follow, the following test procedures were used.

Viscosity:

10.5 grams of adhesive was melted in a Thermosel Brookfield viscometer using an S-27 spindle and an RVT head. Viscosity was recorded after 30 minutes to allow for thermal equilibration.

Tensile:

ASTM D-638 procedure using 12 in/min crosshead speed and a Type IV specimen. At least three specimens per sample were pulled to break. Tensile stress, % Elongation and Energy per cm³ were calculated and the average reported.

Cantilever Test

This test was performed using two pieces of substrate bonded together with an amount of adhesive in the range of 8 to 15 grams/ft² depending on the application. The data reported in this application was based on 12 grams/ft². The substrates (billets) were plywood 5/16″ thick. Uncured adhesive strength (green strength) was evaluated by pulling the billets apart and measuring the force needed to rupture the bond. This is done manually using a hand held scale to record the force in lbs.

Open Time:

Bonds were made in lap shear mode using successively increasing delays before the substrates are combined. At some point in delay time the adhesive will be unable to wet the corresponding surface. The longest time which produced a secure bond was recorded as open time.

### EXAMPLES

Reactive hot melt adhesives having the formulations shown in Table 1 where prepared.

Adhesive Samples A and B are comparative samples. Sample C is representative of an adhesive of the invention.

Batch formulations A, B and C were prepared by heating a mixing vessel capable of running under vacuum to 300° F. All the polyols and non-functional polymers are added to melt and mix under vacuum until homogeneous and free of moisture. Then MDI is added and polymerzation is allowed to proceed with mixing under vacuum until reaction is complete. The resulting pre-polymer is then placed into a container under a dry nitrogen headspace to prevent exposure to moisture.

TABLE

| Material | Sample A | Sample B | Sample C |
|---|---|---|---|
| PPG 2025 | 20 | 39 | 30 |
| PPG 4025 | 20 | — | — |
| DYNACOL 7360 | 20 | — | 12.5 |
| DYNACOL 7380 | — | — | 7.5 |
| RUCO S 105-10 | — | 18 | — |
| ELVACITE 2967 | — | — | 21.5 |
| ELVACITE 2901 | — | — | 16.5 |
| ELVACITE 2016 | 28 | 28 | — |
| MONDUR | 12 | 15 | 12.0 |
| DMDEE | 0.2 | 0.2 | 0.2 |
| Viscosity @ 275° F. | 8,000 | 20,000 | 10,000 |
| 1 hour Tensile psi | 33 | 500 | 1200 |
| 30 sec. Cantilever Test | No Substrate Failure | Partial Substrate Failure | Total Substrate Failure |
| Open Time min. | 4 | 4 | 4 |

PPG 2025 (a polyether polyol - available from Bayer)
PPG 4025 (a polyether polyol - available from Bayer
DYNACOL 7360 (a hexanediol adipate - available from Creanova)
DYNACOL 7380 (a polyester polyol - available from Creanova)
S 105-10 (a hexanediol adipate - available from Ruco)
ELVACITE 2967 (a 17° C. Tg/20,000 Mw acrylic, OH-functional - available from Ineos)
ELVACITE 2901 (an 82° C. Tg/50,000 Mw acrylic, OH-functional - available from Ineos)
ELVACITE 2016 (a 55° C. Tg/65,000 Mw acrylic, OH-functional - available from Ineos)
MONDUR M (4, 4′ MDI available from Bayer)
DMDEE (2,2′ dimorpholinodiethyl ether - available from Rhein Chemie)

Sample A is representative of previous industrial standard for high green strength for the manufacture of RV panels. Sample B is an improvement of that technology which achieves improved green strength via higher molecular weight and hence higher viscosity. The higher viscosity of Sample B is undesirable from a productivity standpoint. Product C utilizes a combination of functionalized acrylics in place of acrylic without functionality to achieve green strength higher than would be anticipated strictly from the molecular weight of the polymers used, without a significant viscosity increase.

Many modifications and variations of this invention can be made without departing from its spirit and scope, as will be apparent to those skilled in the art. The specific embodiments described herein are offered by way of example only, and the invention is to be limited only by the terms of the appended claims, along with the full scope of equivalents to which such claims are entitled.

1. A method of reducing or eliminating bondline failures in articles of manufacture constructed with an adhesive, which articles contain residual stress prior to cure of the adhesive, said method comprises using as the adhesive a reactive hot melt adhesive comprising from about 0 to about 60 parts of a polyether polyol, from about 0 to about 40 parts of a polyester polyol, from about 1 to about 75 parts of a functional acrylic, from about 0 to about 30 parts of a non-reactive acrylic, and from about 2 to about 25 parts of an isocyanate.

2. The method of claim 1 wherein the adhesive comprises from about 15 to about 25 parts of a polyester polyol, from about 15 to about 50 parts of a functional acrylic, and from about 2 to about 25 parts of an isocyanate.

3. The method of claim 2 wherein the adhesive further comprises a polyether polyol and a non-reactive acrylic.

4. The method of claim 1 further comprising a catalyst.

5. The method of claim 4 wherein the catalyst is DMDEE.

6. The method of claim 1 wherein the adhesive further comprises an additive.

7. A method of bonding substrates together, which materials are subject to stress prior to adhesive cure, said method comprising applying a reactive hot melt adhesive composition in a liquid form to a first substrate, bringing a second substrate in contact with the composition applied to the first article, and subjecting the applied composition to conditions which will all the composition to cool and cure to an irreversible solid form, said conditions comprising moisture, wherein the adhesive composition comprises from about 0 to about 60 parts of a polyether polyol, from about 0 to about 40 parts of a polyester polyol, from about 1 to about 75 parts of a functional acrylic, from about 0 to about 30 parts of a non-reactive acrylic, and from about 2 to about 25 parts of an isocyanate.

8. The method of claim 7 wherein the adhesive comprises from about 15 to about 25 parts of a polyester polyol, from about 15 to about 50 parts of a functional acrylic, and from about 2 to about 25 parts of an isocyanate.

9. The method of claim 8 wherein the adhesive further comprises a polyether polyol and a non-reactive acrylic.

10. The method of claim 7 further comprising a catalyst.

11. The method of claim 10 wherein the catalyst is DMDEE.

12. The method of claim 10 wherein the adhesive further comprises an additive.

13. An article of manufacture prepared by the method of claim 7.
